(19) United States
(12) Patent Application Publication
(10) Pub. No.: US 2017/0247119 A1
(43) Pub. Date: Aug. 31, 2017

(54) MATERIAL WEB OF A BELLOWS OF A GANGWAY BETWEEN TWO ARTICULATELY CONNECTED VEHICLES AND MATERIAL WEB OF A CANOPY ROOF OF AN AIR PASSENGER STAIR OR BRIDGE

(71) Applicant: Hübner GmbH & Co. KG, Kassel (DE)

(72) Inventors: Thomas Busch, Reinhardshagen (DE); Andreas Wiegrefe, Fulda/Berhards (DE)

(73) Assignee: Hübner Holding GmbH, Kassel (DE)

(21) Appl. No.: 15/055,758

(22) Filed: Feb. 29, 2016

(51) Int. Cl. B64F 1/305

(52) U.S. Cl. CPC B64F 1/305

(57) ABSTRACT

A material web for a bellows of a gangway between two articulately connected vehicles or a material web for a canopy roof of an air passenger bridge or air passenger stair has at least one reinforcement layer and an elastomer coating on each side of the reinforcement layer. The reinforcement layer is a nonwoven material and an adhesion-promoting layer is disposed between the nonwoven material and the elastomer coatings.

### FIELD OF THE INVENTION

The invention relates to a material web of a bellows of a gangway between two hinge-linked vehicles and to the material web of a canopy roof of an air passenger stair or air passenger bridge.

### BACKGROUND OF THE INVENTION

Bellows of the afore-mentioned type commonly consist of at least one reinforcement layer, usually a woven fabric, wherein the fabric serving as a reinforcement layer is enclosed on both sides by an elastomer. Such webs of material serve to manufacture folding or corrugated bellows. In this context, so-called double corrugated bellows are known, i.e. bellows that are mounted inside one another thus forming the bellows arrangement of a gangway. Such double corrugated bellows are used in particular in high-speed trains and provide amongst others increased sound insulation. In particular, using such double corrugated bellows in high-speed trains prevents pressure surges, which occur when such a high-speed train enters a tunnel or when two high-speed trains meet, from continuing into the vehicle interior; at least the intensity of the pressure surges is reduced.

However, the problem of sound insulation not only applies to high-speed trains, but also in general to all public transportation vehicles, such as tramways or articulated busses. However, one would refrain from mounting such double corrugated bellows or double folding bellows in tramways and busses, on grounds of cost alone. This means that there is definitely an interest in solving the problem of sound insulation in a simpler and primarily in a more cost effective manner.

### SUMMARY OF THE INVENTION

The problem underlying the invention is therefore to provide a material web of the afore-mentioned type that exhibits good acoustical insulation values and that is nonetheless inexpensive to manufacture, so that it may also be used for cost-effective designs of a bellows, e.g. in a tramway or an articulated bus.

Now, it has surprisingly been discovered that when a nonwoven material is provided on both sides with an elastomer coating and is used as a reinforcement layer, with an adhesion promoting layer being provided between the elastomer coating and the nonwoven material, such a web of material not only absorbs noise but ultimately insulates against the noise. In the following, a nonwoven material comprises, by definition, at least one, preferably several layers of a non-crimp fabric of yarns needled to each other, wherein several layers of non-crimp fabrics can also be needled to each other. Each non-crimp fabric layer or one ply of non-crimp fabric comprises a plurality of yarns that can run mono or bi-directionally. The noise-absorbing and insulation effect results from the following: as a non-crimp fabric, the nonwoven material itself absorbs occurring sounds. The coating made of a synthetic material, for example EPDM or silicone, is relatively massive and thus insulates against noise. When combined, they form a web of material that realizes good acoustical insulation values that are similar to insulation values as implemented by double corrugated bellows or a double folding bellows in which a woven fabric is used as reinforcement. Using an adhesion-promoting layer between the nonwoven material on the one hand and the coating made of an elastomer material on the other hand is relevant for achieving good acoustical insulation values. In principle, a nonwoven material is very permeable. If the elastomer coating is applied onto the nonwoven material by means of a calender, there is always a risk that, depending on the height and the density of the nonwoven material, the elastomer material may completely permeate the nonwoven layer. Now, it has surprisingly been discovered that using an adhesion-promoting layer between the nonwoven material on the one hand and the elastomer coating on the other hand prevents the elastomer coating from penetrating deeply into the nonwoven material before and during vulcanization. The adhesion-promoting layer primarily ensures that the elastomer coating remains at the surface of the nonwoven material, while also causing a stable connection with the nonwoven material. If the elastomer coating were to completely permeate the nonwoven material, the sound-absorbing effect of the nonwoven material would tend to zero, which would result, in turn, in poor insulation values with regard to acoustics.

Advantageous features and embodiments of the invention may be gathered from the discussion herein.

The nonwoven material, which may be designed as a nonwoven fabric, a Vliesline, a nonwoven non-crimp fabric or a nonwoven knitted fabric, advantageously comprises several non-crimp fabric layers. As has already been explained, these several layers can be needled to each other as individual non-crimp fabric layers of yarns, in order to achieve a stable bond between the layers.

In particular, the layers are designed and/or connected to each other such that the nonwoven material as a whole can absorb different tensile forces in different directions. This is relevant given that the elongation to be achieved in the longitudinal direction of the vehicle, in particular when driving around a bend, must often be greater, in particular in the area of the lateral wall, than for instance in the roof or floor area. This means that the individual layers or non-crimp fabrics have mono-directionally oriented yarns, wherein individual non-crimp fabric layers of mono-directional yarns rest upon each other in such a manner that the yarns of the individual layers form an angle relative to each other. The consequence thereof is, for example, that when two non-crimp fabric layers of yarns form an angle of 90° relative to each other, such a nonwoven material provides a relatively high extensibility in the direction of a 45° angle but not in angle ranges of around 0° and around 90°. As a direct consequence, the field of application of such a nonwoven material is relatively easily adaptable to external conditions. In this context, it is also conceivable to use yarns of different synthetic materials in the individual non-crimp fabric layers. In this regard, it is conceivable, e.g. for cost reasons, to dispose a non-crimp fabric of polyester as an intermediate layer between two non-crimp fabric layers of Aramid as cover layers. A nonwoven material formed in such a manner would have good flame-retarding properties due to the aramid cover layers.

Advantageously, yarns of different materials, in particular of synthetic materials, can also be used in the non-crimp fabric layers, in order to hereby adapt the entire nonwoven material to different purposes.

According to an advantageous feature of the invention, the nonwoven material has at least one non-crimp fabric layer, in which elastic yarns are disposed. For example, such elastic yarns can be made of silicone or of EPDM. The advantage of a nonwoven material formed in such a manner is that a high elasticity is achieved in one direction, whereas, in the other direction, in which the non-elastic yarns of such a nonwoven with several non-crimp fabric layers extend, there is substantially no or only very little extensibility. Such nonwoven materials with non-crimp fabrics or non-crimp fabric layers of elastic or non-elastic yarns can more specifically be used in places where damage due to vandalism is to be expected. Particularly when the elastic yarns run transversely to an imaginary cutting direction, which is substantially always the case when such yarns, for example in the lateral wall, run parallel to the longitudinal axis of the vehicle, the bellows will only very rarely be cut open along the entire height of the lateral wall. The reason for this is that, depending on the length of the cut, the elastic yarns will build up in the manner of a tree in the direction of the cut, which ensures that the cut cannot be continued without a disproportionally high degree of force.

According to another feature of the invention, it is provided that the yarns of the nonwoven material have different thicknesses. The strength or thickness of the yarns depends in turn on the direction of strain of the material web. In this case, in particular, it can be provided that the yarns of individual layers or non-crimp fabrics of the nonwoven material have different thicknesses, wherein at least one layer with yarns of greater thickness is advantageously embedded between at least two layers with yarns of lesser thickness. The reason for this is that a non-crimp fabric made of a nonwoven of yarns of greater thickness or strength will be more easily permeated by the elastomer than a layer of thinner yarns, assuming that the distance between the yarns is to be identical.

A particularly advantageous feature of the invention is that the at least one outer elastomer layer of the material web comprises a perforation, in particular a so-called micro-perforation, with discrete channels. It is advantageous, if the perforation is provided on the side where the noise is generated, which means that the noise can get through the apertures of the perforation, and here more specifically of the micro-perforation, and reach the nonwoven material, where it is absorbed. A micro-perforation refers to a perforation whose aperture is in the micrometer range.

### BRIEF DESCRIPTION OF THE DRAWINGS

In the following, the invention is exemplarily described in more detail based on the drawings.

FIG. 1 is a schematic view of an articulated vehicle with a bellows as part of the gangway between the two vehicle parts;

FIG. 2 is a schematic view of three non-crimp fabric layers disposed above one another to form a nonwoven material;

FIG. 3 is a schematic view of a cross-sectional view of a nonwoven material coated with an elastomer on both sides;

FIG. 4 is a schematic cross-sectional view of a nonwoven material coated with an elastomer on both sides, wherein the elastomer coating has a perforation on one side.

### DETAILED DESCRIPTION OF THE PREFERRED EMBODIMENTS

According to FIG. 1, the articulated vehicle, labelled 1, features the gangway, labelled 3 as a whole, between the two vehicle parts 2 and 4, wherein the gangway comprises a bellows, labelled 6 as a whole. The bellows 6 is designed as a folding bellows or as a corrugated bellows and has several folding or corrugated webs as material webs connected to each other by sewing, which are moreover held by circumferential bellows frames.

The subject-matter of the invention is the material web for forming the folding or corrugated bellows as part of a gangway between two articulately connected vehicles, in order to allow people to cross from one vehicle part into the other vehicle part without being exposed to weather conditions, by means of the bellows.

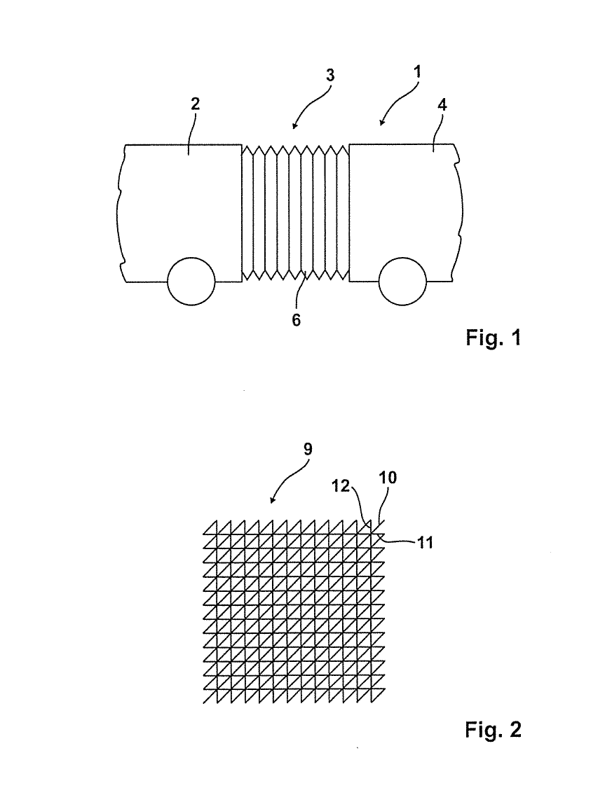

In this context, FIG. 2 shows three layers of non-crimped yarns 10, 11 and 12, which are disposed at an angle of 90°, respectively 45° relative to each other. This means that the yarns of the non-crimp fabric layer 11 are at an angle of 90° relative to the non-crimp fabric layer 12, whereas the non-crimp fabric layer 10 is at an angle of respectively 45° relative to the non-crimp fabric layers 11 and 12. The usable non-crimp fabric layers form the nonwoven material; the nonwoven material forms the material web together with the elastomer coating.

According to FIG. 3, the nonwoven material 9 has four non-crimp fabric layers or non-crimp fabric plies, wherein the yarns of the individual non-crimp fabric layers 11 and 12 are disposed at an angle relative to each other, in particular at an angle of 90°. The reinforcement formed by the nonwoven material 9, which includes the several non-crimp fabric layers 11 and 12, comprises the elastomer coating 21, 22 on both sides for forming the material web 20, wherein it is definitely conceivable to form the elastomer coatings from different elastomer materials. For example, it can be provided that the one outer layer is made of silicone and the other outer layer of an EPDM. An adhesion-promoting layer 7 is provided between the respective elastomer layer on the one hand and the nonwoven material on the other hand, said adhesion-promoting layer ensuring, in addition to an adhesive bond between the elastomer coating and the nonwoven material, that during calendering, i.e. during the coating process, the elastomer coating does not completely permeate the nonwoven material while in the non-vulcanized state. This means that the adhesion-promoting layer serves as a barrier for the elastomer coating. In this respect, depending on the coating material, the adhesion-promoting layer can be formed by a polyolefin adhesion promoter or by a silicone adhesion promoter.

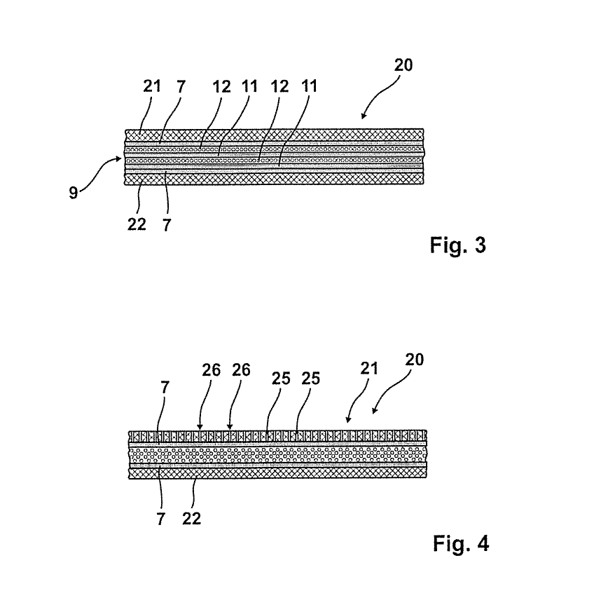

FIG. 4 shows the so-called micro-perforation 26 of the one elastomer coating. The micro-perforation comprises several channels 25, which protrude into the reinforcement designed as a nonwoven material from the outer side of the elastomer coating 21. This perforation, in particular the micro-perforation, is provided on the side of the material web, where the source of the noise is located, i.e. more specifically on the outer side of a bellows.

### LIST OF REFERENCE NUMBERS

1 Articulated vehicle

2 Vehicle part

3 Gangway

4 Vehicle part

6 Bellows

7 Adhesion-promoting layer

9 Nonwoven material

10, 11, 12 Non-crimp fabric layer

20 Material web

21, 22 Elastomer coating

25 Channel

26 Perforation

1. A material web for a bellows of a gangway of the type extending between two articulately connected vehicles or for a canopy roof of the type for an air passenger bridge or air passenger stair, the material web comprising:
at least one reinforcement layer having a pair of opposed sides, the at least one reinforcement layer being formed of a nonwoven material;
an elastomer coating disposed on each of the opposed sides of the at least one reinforcement layer;
wherein an adhesion-promoting layer is disposed between the nonwoven material of the at least one reinforcement layer and each of the elastomer coatings.

2. A material web according to claim 15, wherein the nonwoven material is selected from a group consisting of a nonwoven fabric, a Vliesline, a nonwoven knitted fabric and a nonwoven non-crimp fabric.

3. A material web according to claim 15, wherein the nonwoven material includes a plurality of non-crimp fabric layers.

4. A material web according to claim 17, wherein the plurality of non-crimp fabric layers are formed and/or connected with each other such that the nonwoven material can absorb different tensile forces from a plurality of directions.

5. A material web according to claim 17, wherein each of the non-crimp fabric layers comprises mono-directionally oriented yarns.

6. A material web according to claim 19, wherein the non-crimp fabric layers of mono-directionally oriented yarns rest on one another in such a manner that the yarns of each non-crimp fabric layer are disposed at an angle relative to the other of the non-crimp fabric layers.

7. A material web according to claim 15, wherein the at least one layer of a nonwoven material comprises elastic yarns.

8. A material web according to claim 15, wherein the non-woven material comprises yarns having different thicknesses.

9. A material web according to claim 17, wherein each of the non-crimp fabric layers comprises yarns having a thickness that is different from a thickness of yarns in other of the non-crimp fabric layers.

10. A material web according to claim 23, wherein at least one non-crimp fabric layer with yarns of greater thickness is embedded between at least two layers with yarns of lesser thickness.

11. A material web according to claim 15, wherein at least one of the elastomer coatings has a perforation defined therethrough.

12. A material web according to claim 25, wherein the perforation is a micro-perforation.

13. A material web according to claim 17, wherein at least some of the non-crimp fabric layers have yarns made of different materials than the yarns of other of the non-crimp fabric layers.

14. A material web according to claim 17, wherein the yarns of one of the non-crimp fabric layers are made of different materials.
